(19) United States
(12) Patent Application Publication
(10) Pub. No.: US 2015/0048634 A1
(43) Pub. Date: Feb. 19, 2015

(54) BOX SECURITY COVER AND BOX

(71) Applicant: JENSEN ENTERPRISES, Sparks, NV (US)

(72) Inventors: Joseph Lane Gauntt, Reno, NV (US); Eric R. Schneider, Sparks, NV (US)

(21) Appl. No.: 14/457,939

(22) Filed: Aug. 12, 2014

Related U.S. Application Data
(60) Provisional application No. 61/865,973, filed on Aug. 14, 2013.

(51) Int. Cl. E05B 65/52

(52) U.S. Cl. CPC E05B 65/52
USPC 292/338

(57) ABSTRACT

Embodiments of a box security cover comprising a box cover and a locking assembly are disclosed. The box security cover can be positioned on a box, and the locking assembly can move between an unlocked position in which the security cover can be removed and a locked position in which braces of the locking assembly can contact interior surfaces of the box, preventing removal of the security cover from the box.

### INCORPORATION BY REFERENCE TO ANY PRIORITY APPLICATIONS

This Application claims from the benefit of U.S. Provisional Application No. 61/865,973, filed Aug. 14, 2013, titled “BOX SECURITY COVER AND BOX,” the entirety of which is incorporated herein by reference.

### BACKGROUND

1. Field

The present disclosure relates generally to covers for enclosures and, in particular, to security covers for access enclosures or boxes.

2. Description of the Related Art

Many varieties of box security covers exist, employing a variety of security and locking mechanisms. However, such devices and certain components thereof have various limitations and disadvantages.

### SUMMARY OF THE DISCLOSURE

Disclosed herein are embodiments of a security assembly, comprising a cover configured for placement on a box to block an opening into the box, a locking device attached to a surface of the box cover, the locking device comprising a locking actuator having a longitudinal axis, a driver connected to the locking actuator and configured to move relative to the locking actuator from a locked position to an unlocked position as the locking actuator is turned, at least one locking plate connected to the driver, the locking plate configured to rotate about an axis of rotation to a locked position when the driver moves to a locked position and to rotate about the axis of rotation to an unlocked position when the driver moves to the unlocked position, wherein when the cover is placed on a box, a top portion of the locking plate rotates toward an inner wall of the box as the locking plate rotates to the locked position, and the top portion of the locking plate rotates away from the inner wall as the locking plate rotates to the unlocked position.

In some embodiments, the assembly can further comprise a second locking device attached to the surface of the cover. In some embodiments, the driver can be a threaded nut. In some embodiments, the locking actuator can comprise a recess shaped and sized to fit a tool. In some embodiments, the locking actuator can be at least partially surrounded by a pair of guide plates.

In some embodiments, a connecting member can connect the driver to the at least one locking plate. In some embodiments, the at least one locking plate can comprise a surface configured to increase friction between the at least one locking plate and the inner wall of the box.

Also disclosed herein are embodiments of a box having a locking security mechanism comprising a plurality of walls, an opening on at least one of the plurality of walls, a cover configured for placement on the opening into the box, a locking device attached to a surface of the cover, the locking device comprising a locking actuator having a longitudinal axis, a driver connected to the locking actuator and configured to move relative to the locking actuator from a locked position to an unlocked position as the locking actuator is turned, at least one locking brace connected to operably connected to the locking actuator, the locking brace configured to rotate about an axis of rotation to a locked position in response to movement of said locking actuator in a first direction and to rotate about the axis of rotation to an unlocked position in response to movement of said locking actuator in a second direction, wherein when the cover is placed on the box, a top portion of the locking plate rotates toward an inner wall of the box as the locking brace rotates to the locked position, and the top portion of the locking brace rotates away from the inner wall as the locking brace rotates to the unlocked position.

In some embodiments, the box can be a precast concrete or polymer box. In some embodiments, the box can be manhole.

In some embodiments, the inner wall can be sloped. In some embodiments, the inner wall can be straight. In some embodiments, the inner wall can comprise a lip extending perpendicular to the direction of removal of the cover, the lip configured to prevent movement of the locking device in the locked position. In some embodiments, the inner wall can comprise a recess configured to accept the at least one locking plate in the locked position, thereby preventing movement of the cover.

Also disclosed herein are embodiments of a method of locking a box comprising attaching a cover on an opening in the box, wherein the cover comprises a locking device attached to a surface of the cover, the locking device comprising a locking actuator having a longitudinal axis, a driver connected to the locking actuator and configured to move relative to the locking actuator from a locked position to an unlocked position as the locking actuator is turned, at least one locking plate connected to the driver, the locking plate configured to rotate about an axis of rotation to a locked position when the driver moves to a locked position and to rotate about the axis of rotation to an unlocked position when the driver moves to the unlocked position, wherein when the cover is placed on the box, a top portion of the locking plate rotates toward an inner wall of the box as the locking plate rotates to the locked position, and the top portion of the locking plate rotates away from the inner wall as the locking plate rotates to the unlocked position.

In some embodiments, the cover can be attached to the box during manufacturing of the box. In some embodiments, in the cover can be attached to the box during a retrofit operation.

In various embodiments, a security assembly can include a cover configured for placement on a box to block an opening into the box. A locking device can attach to a surface of the box cover. The locking device can include a locking actuator, such as locking bolt, having a longitudinal axis, a driver connected to the locking actuator and configured to move relative to the locking actuator from a locked position to an unlocked position as the locking actuator is turned, and at least one locking plate connected to the driver. The locking plate can be configured to rotate about an axis of rotation to a locked position when the driver moves to a locked position and to rotate about the axis of rotation to an unlocked position when the driver moves to the unlocked position. In some embodiments, when the cover is placed on a box, a top portion of the locking plate rotates toward an inner wall of the box as the locking plate rotates to the locked position, and the top portion of the locking plate rotates away from the inner wall as the locking plate rotates to the unlocked position.

### BRIEF DESCRIPTION OF THE DRAWINGS

FIG. 1 shows a top perspective view of the top of an embodiment of a box security cover positioned on a box.

FIG. 2 shows a cross-sectional view of an embodiment of a box security cover positioned on a box and in an unlocked position.

FIG. 3 shows a cross-sectional view of an embodiment of a box security cover positioned on the box of FIG. 2 and in a locked position.

FIG. 4 shows a cross-sectional view of an embodiment of a box security cover positioned on a box and in an unlocked position.

FIG. 5 shows a cross-sectional view of an embodiment of a box security cover positioned on the box of FIG. 4 and in a locked position.

FIG. 6 shows an exploded view of an embodiment of a locking assembly.

FIG. 7 shows bottom perspective view of an embodiment of a cover with the guide of one of the locking mechanisms removed for clarity.

### DETAILED DESCRIPTION

With reference to the attached figures, certain embodiments and examples of box security covers will now be described.

Disclosed herein are embodiments of a security cover which can be used to lock different devices, such as a box. A box security cover can be used to limit the ability of unauthorized individuals to access the contents of a box. Such boxes may include, but are not limited to, precast concrete or polymer boxes and boxes marked or unmarked for electric, high voltage, street lighting, traffic signal, ground, signal, communication, cable TV, low voltage, CCTV, water, water meters, etc. Such boxes can be cylindrical, rectangular, or of any shape. In some embodiments, a box can refer to a manhole. A security cover can, when locked, desirably prevent access to the box without special tools.

In various jurisdictions, boxes may be required to satisfy certain design criteria depending on their intended use. For example, in some jurisdictions, boxes intended for use in traffic areas may be required to have vertical interior walls. In some jurisdictions, other interior wall designs may be required for traffic areas or for other intended uses. In some jurisdictions, design criteria are not always required for certain intended uses, but operators of the boxes may prefer certain designs. Various security covers described herein can be adapted for use in boxes of varying designs, such as boxes with vertical interior walls and/or boxes with slanted interior walls. Additionally, various security covers described herein can be used for boxes where the interior walls are flush with an access hole into the box.

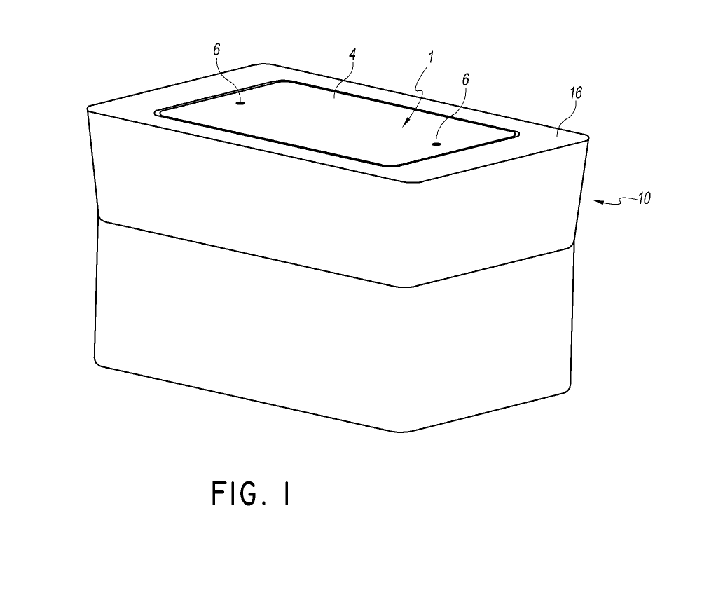

FIG. 1 illustrates a top perspective view of one embodiment of a box security cover 1. The box security cover 1 can seat on a box 10. The box can be generally square, rectangular, round, cylindrical, oval, or of any desired shape, and the shape of the box does not limit the disclosure. The security cover 1 can seat flush with the top surface 16 of the box 10 in order to prevent unwanted removal of the cover 1 by use of, for example, a crow bar. However, in some embodiments, the cover 1 can partially extend away from the top surface 16 of the box 10. In some embodiments, the cover 1 can be fastened to the box 10 so as not to be removed by a crow bar. In addition, the cover 1 can be situated on a surface that is not a top surface, for example a bottom or side surface, and the location of the surface does not limit the disclosure. In some embodiments, multiple security covers 1 can be used to cover different openings in a box 10, or openings that may be larger than just one cover 1.

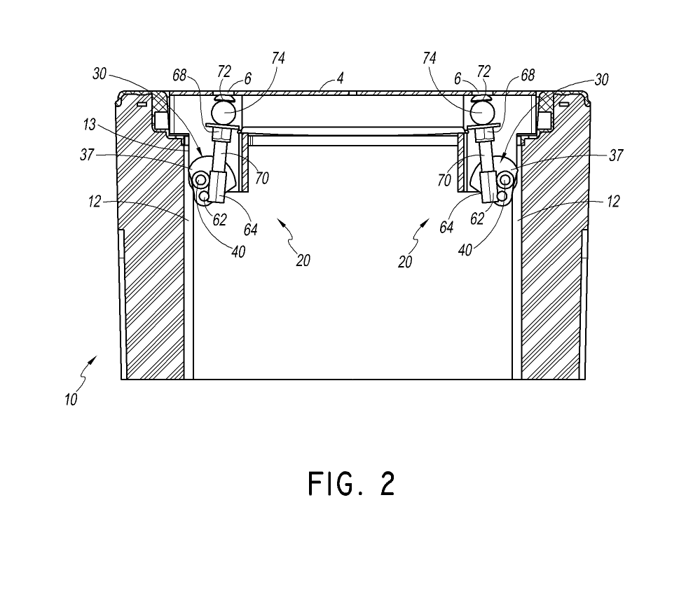

A box security cover 1 can comprise a lid or box cover 4 and one or more locking assemblies 20 attached to the cover 1 and configured to be positioned within the box 10 when the cover 1 is seated on the box 10. Embodiments of a locking assembly are illustrated and described further below with respect to FIGS. 2-6. In some embodiments, the locking assembly 20 can attach to a box cover 1 when the cover 1 is manufactured. In some embodiments, the locking assembly 20 can be used to retrofit an existing box cover 1.

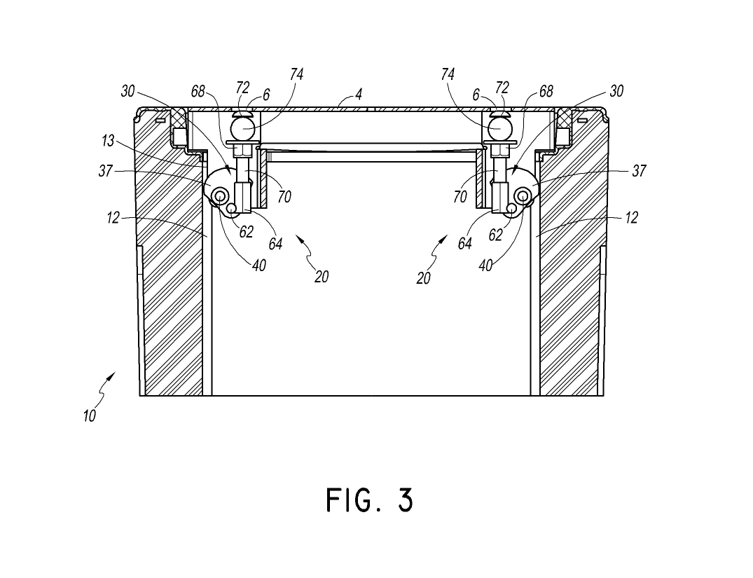

FIGS. 2 and 3 illustrate a cross section of one embodiment of a box 10 that can include one or more locking assemblies 20. The illustrated embodiment has two locking assemblies 20, though more or less assemblies can be used, and the number of locking assemblies does not limit the disclosure. In FIG. 2 the locking assemblies are illustrated in an unlocked position, while FIG. 3 illustrates the locking assemblies in a locked position.

Generally, a locking assembly 20 can include a locking actuator 70 and one or more interference portions, braces, or locking plates 30, though other components can be used as well, as discussed below. In an unlocked position, such as in FIG. 2, the braces 30 can be in an unlocked position where they are a distance away from the inner wall 12 that allows the cover 4 to be removed without the braces contacting the inner wall 12 and preventing removal. In a locked position, such as in FIG. 3, the braces 30 can be in a locked position in which they interact with the inner wall 12 to prevent or hinder removal of the security cover 1. In the locked position, as the cover 1 is being removed, the braces 30 can rotate to increase pressure on the inner walls 12, thus preventing the cover 1 from being removed. For clarity, the edge 13 is recessed rearward from the braces as seen in FIG. 2, so as not to be in contact therewith. In some embodiments, the braces 30 can contact an inner wall 12 generally the whole time when in the locked position. In some embodiments, the braces 30 do not contact the inner wall 12 in the locked position until someone attempts to remove the cover 1. In some embodiments, the braces 30 can be inserted into apertures or recesses in the inner wall 12, thus preventing the cover 1 from being released from the box 10. In some embodiments, the braces 30 can engage with an engagement element on the inner wall 12, thus preventing motion of the cover 1.

In some embodiments, edge 31 of the braces 30 can be configured to contact an interior wall 12 of a box 10 can have roughenings, such as ridges, spikes, or notches, that can help increase friction between the braces 30 and the interior wall 12 of the box 10 to help provide a better lock.

As illustrated in FIGS. 2 and 3, in some embodiments the locking assemblies 20 can be configured to lock a box cover 4 in place on a box 10 that has generally vertical inner walls 12. However, as discussed in more detail below, the inner walls 12 can have different inclines as well while still working with embodiments of the disclosed locking assembly 20. For example, in some embodiments, the inner walls 12 can have a slight incline away from an exterior of the box 10. In some embodiments, the inner walls 12 can have a slight incline toward an exterior of the box 10.

In order to lock the cover 1 to the box 10, in some embodiments the one or more braces 30 can rotate to or from an unlocked or a locked position, although in some embodiments the braces 30 can move into or from a locked position through other mechanisms, such as by translation. In some embodiments, locking actuator 70 can rotate along with braces 30. In embodiments in which the braces 30 rotate to a locked position, each brace 30 can have an axis of rotation, such as one defined by a rod or pin 40 that connect to the brace 30. In some embodiments, the axis of rotation can pass through the largest surface 37 of the brace 30. However, the position of the axis of rotation with respect to brace 30 does not limit the disclosure.

The locking actuator 70, such as a screw, bolt, or other member, can be operated, such as through rotation or translation, to rotate the braces from an unlocked to a locked position and from a locked to an unlocked position. In some embodiments, the locking actuator 70 can connect to a driver, such as a control nut 64, which can be connected to braces 30 at a brace connection or attachment point. In some embodiments, the control nut 64 can be hexagonal or cylindrical, and the shape of control nut 64 does not limit the disclosure. In some embodiments the control nut 64 can connect directly to the braces 30. In some embodiments, it can connect to the braces 30 through an intermediary component, such as a brace connecting rod 62, as shown in FIG. 2. The control nut 64 that can be configured to move up and down the locking actuator 70 as it is turned in a first or second direction, respectively. For example, the nut 64 can be threadably connected to the actuator 70, so as the actuator 70 turns, the nut 64 ascends or descends along the actuator 70. In some embodiments, as the control nut can move 64 up the actuator 70, it can move the brace 30 from an unlocked to a locked position (such as by rotation or translation of the braces 30).

In some embodiments, as the control nut 64 moves up or down the locking actuator 70, the locking actuator 70 can rotate about an axis generally orthogonal to its longitudinal axis and/or an axis generally parallel to an axis of rotation of the brace. This can allow the connection point between the control nut 64 and braces 30 to rotate about the brace axis of rotation as the brace 30 rotates. In some embodiments, the locking actuator 70 can pass through a rotatable shaft 74 that can define an axis of rotation of the locking actuator 70. A nut 68 or other component can be used to maintain the rotatable shaft 74 in position. Further, the nut 68 can also be used to exert force in the opposite direction to dislodge braces 30 in the locked position.

Rotating locking actuator 70 can cause the control nut 64 to travel linearly on the shaft of the actuator 70, thereby changing the distance and direction of an applied force between bore 38 on brace 30 and the rotatable shaft 74. Such action can cause the brace 30 to rotate into the locked or unlocked position through a semi-engaged condition. Rotating locking actuator 70 in one direction can cause brace 30 to move into the locked position, thereby forcing the contact surface or edge 31 of brace 30 to engage the corresponding surface of the inside wall 12 of box 10, thereby securing the cover 1 in place. Attempts made to remove the cover 1 by pulling, prying, lifting, or other means when the braces 30 are in the locked position can cause the braces 30 to rotate farther into the locked position. Rotating locking actuator 70 in the opposite direction can reverse the distance and direction of a force between bore 38 and the rotatable shaft 74. Doing so can force brace 30 to disengage with the wall 12 of the box 10 and move into the unlocked position. Rotating actuator 70 in a direction that moves brace 30 into an unlocked position can force brace 30 into the unlocked position even when bounded in the locked position, thereby assuring that the cover 1 may always be removed as desired by authorized personnel.

In some embodiments, the locking actuator 70 can be configured to remain in a specific rotational position as the control nut 64 moves up or down. The connection point between the control nut 64 and braces 30 can move relative to the axis of rotation of the brace 30, such as the axis defined by the rod or pin 40, to cause the brace 30 to rotate. In some embodiments, where the control nut 64 connects to the braces 30 through a brace connecting rod 62, the brace 30 can have a slot that receives the connecting rod 62 and allows the connecting rod 62 to move relative to the rod or pin 40. However, attachment of the connecting rod 62 and brace 30 does not limit the disclosure.

In some embodiments, a head 72 of the locking actuator 70 can be accessed from outside of the box 10 to rotate the locking actuator 70 and move the control nut 64. In some embodiments, an upper surface of the box cover 4 can comprise a recess 6 that can receive the head 72. The recess 6 can be configured such that the head remains below or level with the upper surface of the cover 4. The recesses 6 can be generally sized and shaped to that of the head 72. This can prevent the actuator 70 from interfering with activity on the upper surface, and also makes it more difficult to access the actuator 70 to unlock the security mechanism. In some embodiments, the head 72 can extend partially out of the box cover 4. Additionally, the actuator 70 can be of a non-standard design such that it requires a special tool to manipulate, or can have other tamper-resistance features to make its removal by unauthorized individuals more difficult.

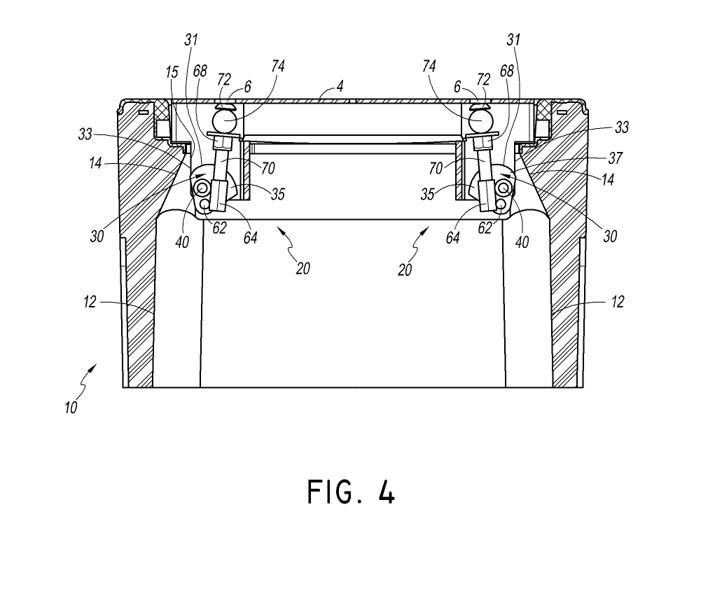

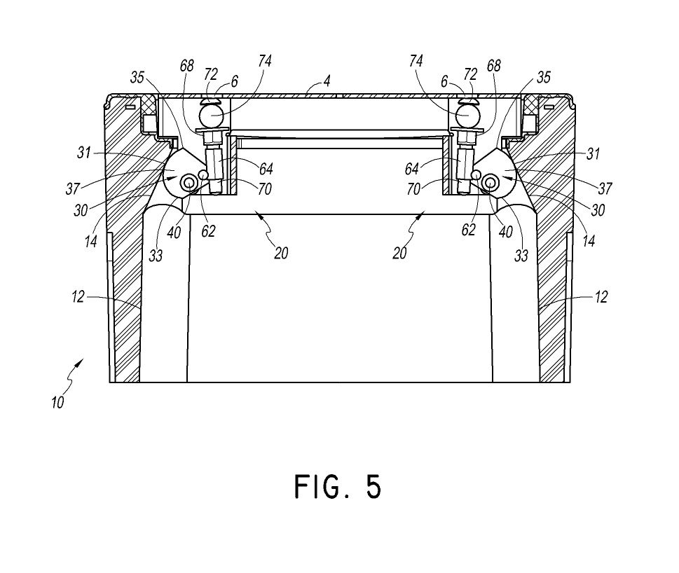

In some embodiments, a box 10 can have different types of interior surfaces, and the interior of the box 10 does not limit the disclosure. Various embodiments of the locking assemblies 20 described herein can be used with boxes of varying interior surfaces. For example, FIGS. 4 and 5 illustrate an embodiment of a locking assembly 20 for use with a lid on a box 10 with an inner wall 12 that has a sloped section 14. FIG. 4 illustrates the locking assembly in an unlocked position, and FIG. 5 illustrates the locking assembly in a locked position. For clarity, the edge 31 is recessed rearward from the braces 30 as seen in FIG. 4, so as not to be in contact therewith. In some embodiments, the edge 31 of the braces 30 configured to contact an interior wall 12 of a box 10 can have various profiles in the illustrated plane. In some embodiments, the edge 31 can be arcuate in the illustrated plane. In some embodiments, the edge 31 can have a profile adapted for use with a specific type of inner wall 12, or can have a profile configured to maximize the effectiveness of the braces 30 for use with a variety of wall designs, and the profile of the edge 31 does not limit the disclosure. For example, the profile of the edge 31 can be such that a first end 33 of the edge 31 is closer to the brace axis of rotation than a second end 35 of the edge. This can help allow the locking assembly 20 to be effectively used within a greater range of distances between the brace axis of rotation and the inner wall 12 of a box 10.

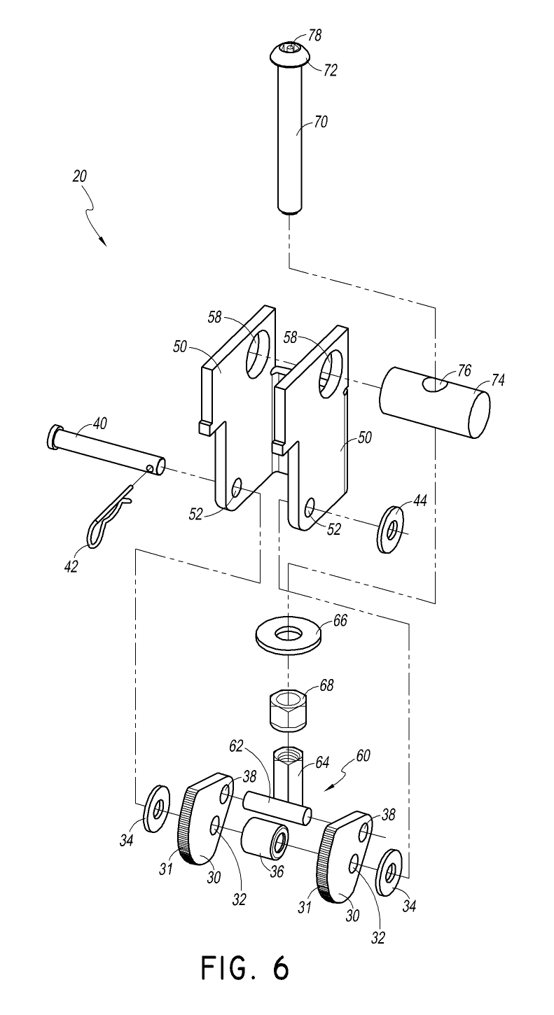

FIG. 6 illustrates an exploded view of one embodiment of a locking assembly 20. As described above, a locking assembly 20 can generally comprise a locking actuator 70, such as a bolt or screw, which can be movably attached to one or more braces 30. For example, the locking actuator 70 can be attached to a control nut 64, which can move up or down the locking actuator 70 as it is rotated. The control nut can be attached to a brace connecting rod 62, which can connect to the braces 30, such as by insertion into a hole or bore 38 on the braces. In some embodiments, the control nut 64 can be soldered, brazed, welded, or any other means of attachment, to the brace connecting rod 62. Therefore, when the actuator 70 is rotated, the braces 30 can be rotated as well. In some embodiments, the control nut 64 and the brace connecting rod 62 can be formed as one integral piece. The perpendicular axis of connecting rod 62 and control nut 64 can be intersecting or offset any distance.

In some embodiments, the braces 30 can have a second hole or bore 32 that can receive a rod or pin 40 that defines an axis of rotation for the braces 30. The relationship of the contact surface or edge 31 and the axis of rotation defined by bore 32 can be spirally eccentric. However, other eccentricities can be used as well. For example the axis of rotation can be elliptically eccentric, circularly eccentric, or in any other way increasing the distance between surface or edge 31 and bore 32 in various degrees of rotation of brace 30. Various components can be used to help limit wear on the braces or provide additional support as they rotate, such as various washers 34, 44 and/or a spacer 36 positioned between the braces. The rod or pin 40 can be maintained in position with, for example, a locking pin 42. In some embodiments, a nut or other mechanical locking component can be used to keep the rod or pin 40 in position. However, different components can be used as well, and these components do not limit the disclosure.

In some embodiments, the rod or pin 40 defines an axis of rotation of the braces 30 that is offset from the location where the control nut 64 and/or brace connecting rod 62 attach to the braces 30. Thus, when the control nut 64 moves up or down the locking actuator 70, it can provide a moment about the axis of rotation of the braces 30, rotating them from an unlocked to a locked position or from a locked to an unlocked position. In some embodiments, in order for the motion of the control nut 64 to cause a rotation of the braces 30, and not bind the braces 30 by attempting to translate them out of position, the locking actuator 70 can be configured to rotate about an axis of rotation different from its longitudinal axis. In some embodiments, the locking actuator 70 can pass through a bore 76 on a rotatable shaft 74 that defines an axis of rotation for the locking actuator 70. The axis may also be fixed or defied in other ways if an intermediary component such as a linkage rod is used. The axis can be generally orthogonal to the longitudinal axis of the locking actuator 70 and/or the axis can be generally parallel to the axis of rotation of the braces 30. The relationship of bore 76 and bore 38 that can define the axis of actuator 70, and the axis can vary at different degrees of rotation of brace 30. A washer 66 and/or locking nut 68 can be used to help maintain the positioning of the rotatable shaft 74 and the locking actuator 70. Further, the washer 66 can be used to center the rotatable shaft 75 between guide plates 50, though other centering mechanisms can be used as well. In some embodiments, a frame can be used to anchor the various components, such as the rod or pin 40 and/or the rotatable shaft 74, that define the various axes of rotation. In some embodiments, the frame can be used to attach the locking assembly to the lid of a box.

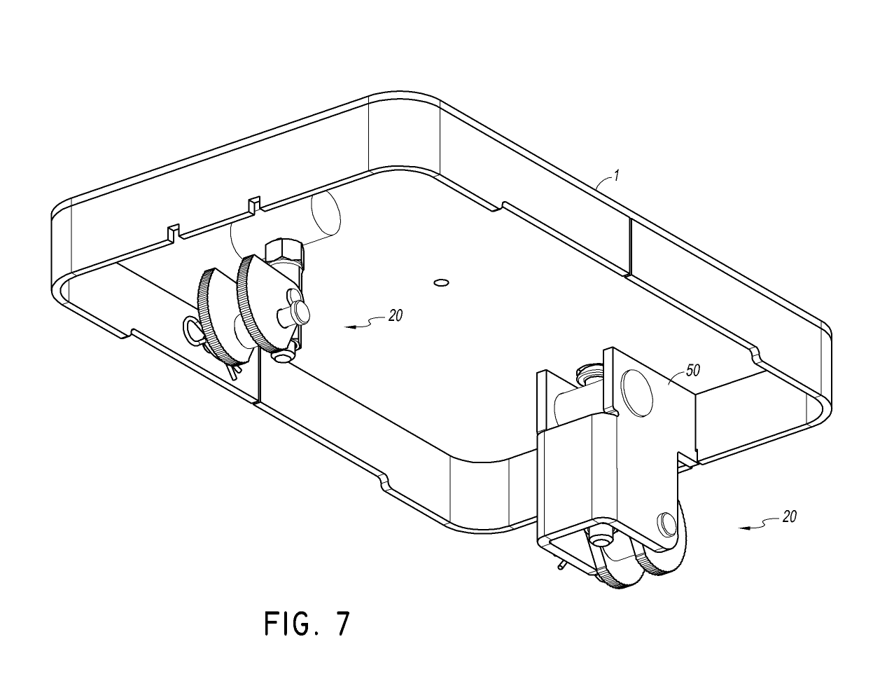

As illustrated in FIG. 6, in some embodiments a frame can comprise a plurality of guide plates 50. In some embodiments, the guide plates 50 can be mirror images of one another. The guide plates 50 can each have a first bore 52 that can be configured to receive the rod or pin 40 and help define an axis of rotation of the braces 30. The plates 50 can also each comprise a second bore 58 that can be configured to receive the rotatable shaft 74 and help define an axis of rotation of the locking actuator 70. In some embodiments, the plates 50 can be attached to the underside of cover 1, as shown in FIG. 7. In some embodiments, the plates 50 can be welded, soldered, or brazed welded to the cover 1. In some embodiments, the plate 50 can be bolted to the underside of cover 1. In some embodiments, the cover 1 and guide plates 50 can be formed as one integral part, such as one cast iron piece. In some embodiments, the cover 1 and guide plates 50 can be cast. In some embodiments, the guide plates 50 can be cast into a concrete or polymer, for example, cover 1.

In some embodiments, the locking actuator 70 can have a head 72 with a recess 78 configured to receive a tool used to rotate the locking actuator 70 about its longitudinal axis and thereby move the control nut 64 up or down the locking actuator 70. In some embodiments, the recess 78 can have a variety of nonstandard shapes configured to receive tools specially configured for use with the particular locking actuator 70. In some embodiments, rotating the locking actuator 70 in a clockwise direction can be used to move the control nut closer towards the head 72 and move the braces 30 from an unlocked to a locked position. In some embodiments, moving the control nut 64 closer towards the head 72 can be configured to move the braces 30 from a locked to an unlocked position. In some embodiments, rotating the locking actuator 70 in a clockwise direction can move the control nut 64 farther away from the head 72 of the locking actuator. However, the direction of the ration of the actuator 70 does not limit the disclosure.

In some embodiments, the connection point between the control nut 64 and the brace 30 can be on an interior side of the axis of rotation of the brace. In other words, the connection point can be closer to a center of a box 10 when the locking assembly 20 is attached to a lid and within the box 10, as illustrated in FIGS. 2-5. In some embodiments, the connection point can be on an exterior side of the axis of rotation of the brace 30. In some embodiments, a brace 30 can rotate such that a top portion of the brace rotates toward the inner wall 12 and a bottom portion of the brace rotates away from the inner wall 12. This can happen, for example, where the connection point is on the interior side of the brace axis of rotation and where moving the control nut closer to the head 72 moves the braces toward the locked position.

From the foregoing description, it will be appreciated that an inventive product and approaches for a box security device are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount.

Some embodiments have been described in connection with the accompanying drawings. The figures are drawn to scale, but such scale should not be limiting, since dimensions and proportions other than what are shown are contemplated and are within the scope of the disclosed inventions. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A security assembly, comprising:
a cover configured for placement on a box to block an opening into the box; and
a locking device attached to a surface of the box cover, the locking device comprising:
a locking actuator having a longitudinal axis;
a driver connected to the locking actuator and configured to move relative to the locking actuator from a locked position to an unlocked position as the locking actuator is turned;
at least one locking brace connected to the driver, the locking brace configured to rotate about an axis of rotation to a locked position when the driver moves to a locked position and to rotate about the axis of rotation to an unlocked position when the driver moves to the unlocked position;
wherein when the cover is placed on a box, a top portion of the locking plate rotates toward an inner wall of the box as the locking plate rotates to the locked position, and the top portion of the locking plate rotates away from the inner wall as the locking plate rotates to the unlocked position.

2. The security assembly of claim 1, further comprising a second locking device attached to the surface of the cover.

3. The security assembly of claim 1, wherein the driver is a threaded nut.

4. The security assembly of claim 1, wherein the locking actuator comprises a recess shaped and sized to fit a tool.

5. The security assembly of claim 1, wherein the locking actuator is at least partially surrounded by a pair of guide plates.

6. The security assembly of claim 1, wherein a connecting member connects the driver to the at least one locking plate.

7. The security assembly of claim 1, wherein the at least one locking plate comprises a surface configured to increase friction between the at least one locking plate and the inner wall of the box.

8. A box having a locking security mechanism comprising:
a plurality of walls;
an opening on at least one of the plurality of walls;
a cover configured for placement on the opening into the box;
a locking device attached to a surface of the cover, the locking device comprising:
a locking actuator having a longitudinal axis;
a driver connected to the locking actuator and configured to move relative to the locking actuator from a locked position to an unlocked position as the locking actuator is turned;
at least one locking brace connected to operably connected to the locking actuator, the locking brace configured to rotate about an axis of rotation to a locked position in response to movement of said locking actuator in a first direction and to rotate about the axis of rotation to an unlocked position in response to movement of said locking actuator in a second direction;
wherein when the cover is placed on the box, a top portion of the locking plate rotates toward an inner wall of the box as the locking brace rotates to the locked position, and the top portion of the locking brace rotates away from the inner wall as the locking brace rotates to the unlocked position.

9. The box of claim 8, wherein the box is a precast concrete or polymer box.

10. The box of claim 8, wherein the box is manhole.

11. The box of claim 8, wherein the inner wall is sloped.

12. The box of claim 8, wherein the inner wall is straight.

13. The box of claim 8, wherein the inner wall comprises a lip extending perpendicular to the direction of removal of the cover, the lip configured to prevent movement of the locking device in the locked position.

14. The box of claim 8, wherein the inner wall comprises a recess configured to accept the at least one locking brace in the locked position, thereby preventing movement of the cover.

15. A method of locking a box comprising:
attaching a cover on an opening in the box, wherein the cover comprises:
a locking device attached to a surface of the cover, the locking device comprising:
a locking actuator having a longitudinal axis;
a driver connected to the locking actuator and configured to move relative to the locking actuator from a locked position to an unlocked position as the locking actuator is turned;
at least one locking plate connected to the driver, the locking plate configured to rotate about an axis of rotation to a locked position when the driver moves to a locked position and to rotate about the axis of rotation to an unlocked position when the driver moves to the unlocked position;
wherein when the cover is placed on the box, a top portion of the locking plate rotates toward an inner wall of the box as the locking plate rotates to the locked position, and the top portion of the locking plate rotates away from the inner wall as the locking plate rotates to the unlocked position.

16. The method of claim 15, wherein the cover is attached to the box during manufacturing of the box.

17. The method of claim 15, wherein in the cover is attached to the box during a retrofit operation.
